(19) United States
(12) Patent Application Publication
(10) Pub. No.: US 2026/0030767 A1
(43) Pub. Date: Jan. 29, 2026

(54) METHOD FOR STITCHING FORWARD-LOOKING SONAR IMAGES WHILE RETAINING INFORMATION

(71) Applicant: ZHEJIANG UNIVERSITY, Zhoushan (CN)

(72) Inventors: Yan WEI, Zhoushan (CN); Jiayi SU, Zhoushan (CN); Xingbin TU, Zhoushan (CN); Fengzhong QU, Zhoushan (CN); Ying CHEN, Zhoushan (CN)

(21) Appl. No.: 18/996,765

(22) PCT Filed: Sep. 19, 2024
(86) PCT No.: PCT/CN2024/092190

§ 371 Date: Jan. 17, 2025

(30) Foreign Application Priority Data
Mar. 10, 2023 (CN) 202310227303.6

(51) Int. Cl. G06T 7/32; G01S 15/89; G06T 3/04; G06T 3/14; G06T 3/60; G06T 7/35; G06T 7/37

(52) U.S. Cl. CPC G06T 7/32; G01S 15/89; G06T 3/04; G06T 3/14; G06T 3/60; G06T 7/35; G06T 7/37; G06T 2207/10016; G06T 2207/20216; G06T 2207/20221

(57) ABSTRACT

A method for stitching forward-looking sonar images while retaining information is provided. In this application, forward-looking sonar is used as underwater detection equipment and acquired forward-looking sonar images are stitched together. A phase correlation method is employed for estimating displacements between images to determine the position of each single forward-looking sonar image within the stitched image. A method based on local statistics is used for image blending to obtain a stitched forward-looking sonar image that retains information. The method for stitching forward-looking sonar images proposed in this application adapts to intra-frame and inter-frame artifacts caused by non-ideal sonar imaging configurations, overcoming the drawbacks of image quality degradation due to the intra-frame and inter-frame artifacts. The method enhances the amount of information contained in the stitched image, which can assist observers in conducting rapid underwater exploration.

### CROSS REFERENCE TO RELATED APPLICATION

The present application is a national stage application of International Patent Application No. PCT/CN2024/092190, filed on May 10, 2024, which claims priority to the Chinese Patent Application No. 202310227303.6, filed with the China National Intellectual Property Administration (CNIPA) on Mar. 10, 2023, and entitled “METHOD FOR STITCHING FORWARD-LOOKING SONAR IMAGES WHILE RETAINING INFORMATION”, which is incorporated herein by reference in its entirety.

### TECHNICAL FIELD

The present disclosure relates to the field of computer vision, and in particular, to a method for stitching forward-looking sonar images while retaining information.

### BACKGROUND

Underwater detection technology is one of the most widely used marine technologies. Tasks such as underwater search and rescue, dock safety inspection, and exploration of underwater biological habitats all require support from underwater detection technology. Sonar has gained attention due to its characteristics such as being less affected by the turbidity of water and having a long detection range. Forward-looking sonar, as an emerging type of sonar, has become a hot research topic in underwater detection technology due to its extremely high imaging resolution, high frame rate, and relatively low cost.

Currently, methods utilizing forward-looking sonar for underwater detection mainly include: adapting target recognition methods suitable for cameras to forward-looking sonar, and performing target recognition on captured single forward-looking sonar images to accomplish target search tasks. However, the acquisition of underwater sonar data is challenging and costly, and data-driven approaches are still in their early stages. Moreover, methods based on single images cannot be applied to non-target search detection tasks, such as observing underwater biological habitat environments. To address these challenges, stitching forward-looking sonar images to form a complete acoustic image can significantly reduce the overall data volume and greatly accelerate the review speed of the operator. Additionally, stitched images are suitable for non-target search tasks such as underwater environmental observation.

Existing methods for stitching forward-looking sonar images do not consider intra-frame and inter-frame artifacts caused by non-ideal sonar imaging configurations. As a result, the resulting stitched images are often overly blurred and lack information of interest to the observer. Intra-frame artifacts mainly arise from uncertainties in sonar installation angles, vehicle altitude and depth, as well as artifacts generated during sonar imaging, while inter-frame artifacts mainly stem from low positioning accuracy, cumulative inter-frame pose estimation errors, and changes in detection view point.

In practical applications, due to various factors such as economic costs, time constraints, and technological immaturity, forward-looking sonar often operates under non-ideal imaging configurations, making intra-frame and inter-frame artifacts unavoidable. Therefore, developing a method for stitching forward-looking sonar images that adapts to non-ideal sonar imaging configurations and considers both intra-frame and inter-frame artifacts is of significant and important help in practical applications.

### SUMMARY

An objective of the present disclosure is to provide a method for stitching forward-looking sonar images while retaining information, addressing the shortcomings in the prior art.

The objective of the disclosure is achieved as follows: a method for stitching forward-looking sonar images while retaining information, including: acquisition of a forward-looking sonar image sequence, image registration, information extraction, and image blending.

The image registration specifically includes: estimating relative rotational displacements of the forward-looking sonar image sequence using a phase correlation method, accumulating to obtain a global rotational displacement, and applying the global rotational displacement to images to obtain a preliminary stitched image.

The information extraction specifically includes: subjecting the forward-looking sonar image sequence to a temporal window method and a spatial window method to obtain local variance statistics and local background variance statistics, combining the local variance statistics and the local background variance statistics based on weights to obtain corrected local variance statistics, and combining the corrected local variance statistics with the global rotational displacement to obtain a global variance map.

The image blending specifically includes: forming a final stitched result from the preliminary stitched image under an influence of the global variance map.

Further, said estimating the relative rotational displacements of the forward-looking sonar image sequence using the phase correlation method specifically includes: estimating relative rotational displacements between forward-looking sonar images at adjacent times using a phase correlation method based on Fourier-Mellin transform.

Further, the local variance statistics are calculated using the following method:
calculating pixel value variances ν∈ [symbol] of each forward-looking sonar image within a spatial window s₁ and a temporal window t₁, where [symbol] represents a set of pixel value variances within the spatial window s₁ and the temporal window t₁, constituting the local variance statistics.

The local background variance statistics are calculated using the following method:
calculating pixel value variances of each forward-looking sonar image within a spatial window s₂ and a temporal window t₂ to obtain b∈ [symbol] , where [symbol] represents a set of pixel value variances within the spatial window s₂ and the temporal window t₂, constituting the local background variance statistics.

Further, to ensure that the calculated variance value better represents a local inherent background variance of the image, it is set that s₂≥s₁; to ensure that the calculated variance value avoids the influence of local effective information of the image on background modeling, it is set that t₂»t₁.

Moreover, the global variance map [symbol] ∈ [symbol] ^{M×N×L} is specifically obtained by sorting the pixel value variances ν within the spatial window s₁ and the temporal window t₁ in descending order; selecting top L ν values, and storing the selected ν values at spatial positions corresponding to the ν values in [symbol] , where the spatial position of the ν value is obtained by adding local coordinates of a pixel on a specific sonar image to global coordinates of the sonar image obtained through image registration; and repeating this step M×N times to obtain [symbol] , where M represents a width of the stitched image, N represents a height of the stitched image, M and N denoting a size of a minimum bounding rectangle of an irregular image after stitching; and L represents the number of variance values to be stored.

Further, before the pixel value variance ν is stored in [symbol] , the pixel value variance ν is adjusted based on the background variance b∈ [symbol] , with a specific method being ν_{new}=ƒ(ν_{old}, b), where ƒ is a function for adjusting the ν value based on the background variance, b is obtained by calculating the pixel value variances of each forward-looking sonar image within the spatial window s₂ and the temporal window t₂, b∈ [symbol] , ν_{old} is a pixel value variance before adjustment, and ν_{new} is a pixel value variance after adjustment.

Further, said forming the final stitched result from the preliminary stitched image under the influence of the global variance map is specifically as follows: a pixel value at each coordinate position of the stitched image is obtained by averaging pixel values from the forward-looking sonar images corresponding to L values at a corresponding coordinate position on the global variance map [symbol] , where L represents the number of variance values to be stored.

The present disclosure has the following beneficial effects: this method adapts to non-ideal sonar imaging configurations, and considers both intra-frame and inter-frame artifacts. Single images with high local variance values, which often contain effective information are selected for weighted averaging. This avoids a decrease in the proportion of effective information caused by the participation of images with low local variance values, which often do not contain information, in the averaging process. This method can retain image information required by the observer, assist the observer in underwater detection, and reduce the volume of underwater detection data.

### BRIEF DESCRIPTION OF THE DRAWINGS

FIG. 1 is a schematic diagram of forward-looking sonar image stitching;

FIG. 2 illustrates a method for stitching forward-looking sonar images while retaining information; and

FIG. 3 is a system block diagram of a method for stitching forward-looking sonar images while retaining information.

### DETAILED DESCRIPTION OF THE EMBODIMENTS

To make the foregoing objectives, features, and advantages of the present disclosure clearer and more comprehensible, the specific implementations of the present disclosure are described in detail below with reference to the drawings.

Many specific details are set forth in the following description to facilitate full understanding of the present disclosure, but the present disclosure may also be implemented in other ways different from those described herein, similar derivatives may be made by those skilled in the art without departing from the connotation of the present disclosure, and therefore, the present disclosure is not limited by the specific embodiments disclosed below. The specific implementation method of the present disclosure is further described below with reference to the accompanying drawings.

Traditional underwater detection technology based on forward-looking sonar relies on target recognition from single sonar images. However, due to the high cost of acquiring underwater acoustic images and the singular data modality, data-driven deep learning target recognition methods that work well with camera images often yield poor results when applied to forward-looking sonar images. Moreover, target recognition algorithms are not suitable for some tasks, such as observing underwater biological habitats. Therefore, detection methods based on stitched images have gained attention. Firstly, they can solve the aforementioned problems; secondly, they express data in a more compact manner, accelerating the review speed of observers and reducing the data volume. However, existing image stitching methods based on forward-looking sonar do not consider intra-frame and inter-frame artifacts caused by non-ideal sonar imaging configurations. As a result, the resulting stitched images are often overly blurred and lack information of interest to the observer. Intra-frame artifacts mainly arise from errors in sonar installation angles, vehicle altitude and depth errors, and sonar imaging errors, while inter-frame artifacts mainly stem from low positioning accuracy, cumulative inter-frame pose estimation errors, and changes in detection view point.

The present disclosure provides a method for stitching forward-looking sonar images while retaining information. This method adapts to non-ideal sonar imaging configurations, and considers both intra-frame and inter-frame artifacts. Single images containing effective information are selected for weighted averaging. This avoids a decrease in the proportion of effective information caused by the participation of images, which do not contain information, in the averaging process. This method can retain image information required by the observer, assist the observer in underwater detection, and reduce the volume of underwater detection data.

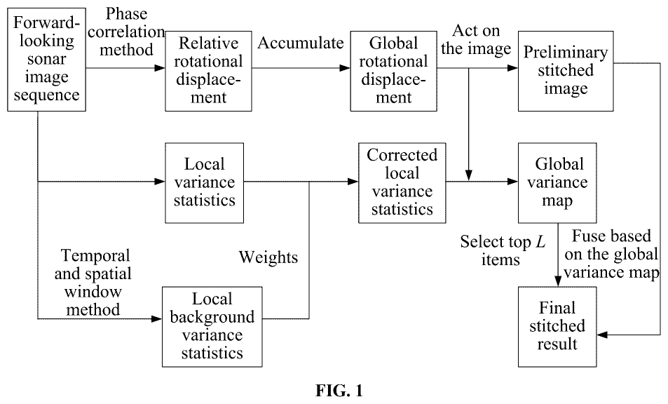

This method includes acquisition of a forward-looking sonar image sequence, image registration, information extraction, and image blending. As shown in FIG. 1, after the forward-looking sonar image sequence is acquired, relative rotational displacements of images in the sequence are estimated using a phase correlation method, and are then accumulated to obtain a global rotational displacement, which is applied to the images to obtain a preliminary stitched image. This step is used to estimate the relative rotational displacements between forward-looking sonar images captured at adjacent times to determine coordinate positions of each image within a final stitched image. On the other hand, local variance statistics and local background variance statistics are obtained from the forward-looking sonar images using a temporal window method, which are then combined in a weighted manner to form corrected local variance statistics. The corrected local variance statistics, combined with a global rotational displacement, can yield a global variance map. A final stitched result is formed under an influence of the global variance map. This step involves determining content of the stitched image based on overlapping content of the sonar images.

A detailed description is given below.

Image registration step: The forward-looking sonar images are arranged according to their measurement timestamps, and any pair of temporally adjacent images is denoted by f₁(x, y) and f₂(x, y), where x and y represent pixel coordinates. Assuming that f₂(x, y) is a copy of f₁(x, y) after rotation by θ₀ and translation by x₀ and y₀, it is obtained that:

$${f}_{2} ( x , y ) = {f}_{1} ( x cos {θ}_{0} + y sin {θ}_{0} - {x}_{0} , - x sin {θ}_{0} + y cos {θ}_{0} - {y}_{0} ) .$$

By applying the Fourier transform to both sides of the equation based on the Fourier translation and rotation properties, it is obtained that:

$${F}_{2} ( ξ , η ) = {e}^{- j 2 π ( ξ {x}_{0} + η {y}_{0} )} \times {F}_{1} ( ξcos {θ}_{0} + ηsin {θ}_{0} , - ξsin {θ}_{0} + ηcos {θ}_{0} ) .$$

frequency coordinates corresponding to the x and y directions.

With M₁ and M₂ representing the magnitudes of F₁ and F₂, respectively, the above expression is transformed into the following form:

$${M}_{2} ( ξ , η ) = {M}_{1} ( ξcos {θ}_{0} + ηsin {θ}_{0} , - ξsin {θ}_{0} + ηcos {θ}_{0} ) .$$

By expressing the above expression is polar coordinates, it is obtained that:

$${M}_{1} ( ρ , θ ) = {M}_{2} ( ρ , θ - {θ}_{0} ) .$$

ρ represents a distance and θ represents an angle.

Simultaneously, assuming that f₂(x, y) is a copy of f₁(x, y) that has only been translated, it is obtained that:

$${f}_{2} ( x , y ) = {f}_{1} ( x - {x}_{0} , y - {y}_{0} ) .$$

By applying the Fourier transform to both sides of the equation, based on the Fourier translation property, it is obtained that:

$${F}_{2} ( ξ , η ) = {e}^{- j 2 π ( ξ {x}_{0} + η {y}_{0} )} * {F}_{1} ( ξ , η ) .$$

By transforming the above expression, a cross-power spectrum is obtained:

$$\frac{{F}_{2} ( ξ , η ) {F}_{1}^{*} ( ξ , η )}{\vert {F}_{2} ( ξ , η ) {F}_{1}^{*} ( ξ , η ) \vert} = {e}^{- j 2 π ( ξ {x}_{0} + η {y}_{0} )} .$$

This results in a phase correlation matrix, where there is a peak at x₀ and y₀. By locating the coordinates of the peak, the displacement of the image can be inferred. Thus, it can be concluded that the rotation angle can be determined using phase correlation in polar coordinates, and this method can be used to obtain the rotation and translation of the image. By accumulating the relative rotational displacements, an absolute rotational displacement Tₜ∈ [symbol] ^{2×2} of a single forward-looking sonar image Iₜ∈ [symbol] captured at time point t with respect to the global coordinate system can be obtained. Tₜ belongs to a special orthogonal group SE(2), and [symbol] represents the set of all forward-looking sonar images. Tₜ is applied to Iₜ, such that Iₜ is placed at specified coordinates of the stitched image, thereby generating the preliminary stitched image.

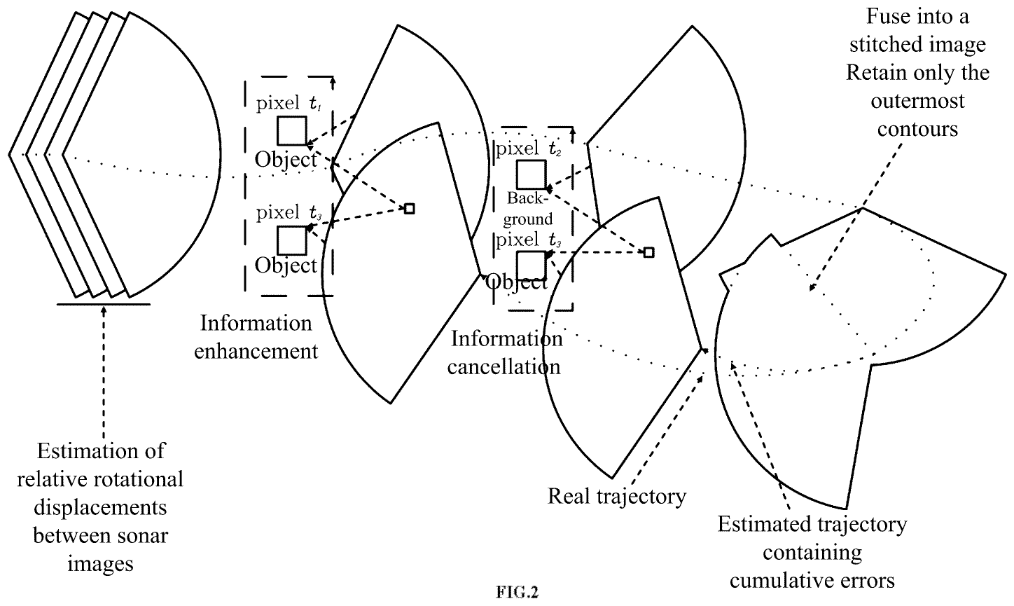

In FIG. 2, the sector images represent schematic forward-looking sonar images. The distribution of the sector images in FIG. 2 illustrates the effect of applying Tₜ to Iₜ. Edge contours of the forward-looking sonar images located at the outermost part of the coordinate system are preserved, becoming edge contours of the final stitched image. The content within the contours represents the content of the stitched image. The partially overlapping and partially diverging dashed lines in FIG. 2 represent the actual trajectory of the forward-looking sonar and the estimated trajectory containing cumulative errors. Since forward-looking sonar often operates under non-ideal imaging configurations, it inevitably faces the impacts of intra-frame and inter-frame artifacts. Taking the inter-frame artifacts caused by cumulative pose estimation errors as an example, under ideal pose estimation, when the sonar detects the same object at different times, local pixels representing the object should overlap when projected into the global coordinate system, achieving an information enhancing effect, such as noise reduction. However, due to the accumulation of pose estimation errors, in practical applications, related pixels often fail to be projected to the same coordinate position. When pixel points representing an object are projected onto background pixels (which often represents missing information in the seabed reverberation in forward-looking sonar applications), effective pixel information can be canceled out during the image blending step based on pixel value averaging. In FIG. 2, these two situations are indicated by two dashed boxes. The dashed box on the left contains two pixels that are from different forward-looking sonar images and located at the same global coordinate position. Since these pixel coordinates come from the actual trajectory, they both represent object information. Therefore, the object information is enhanced. The dashed box on the right also contains pixels that are from different forward-looking sonar images and located at the same global coordinate position. These pixel coordinates come from the estimated trajectory with cumulative errors, thus representing different object information. Therefore, the object information is weakened. It can be seen that the image blending step proposed in the present disclosure can effectively address the above issues.

Information extraction step: This step generates a stitched image based on the global variance map and forward-looking sonar images after rotational displacement compensation. The global variance map [symbol] ∈ [symbol] ^{M×N×L} is specifically obtained by sorting the pixel value variances ν within the spatial window s₁ and the temporal window t₁ in descending order; selecting top L ν values, and storing the selected ν values at spatial positions corresponding to the ν values in [symbol] , where the spatial position of the ν value is obtained by adding local coordinates of a pixel on a specific sonar image to global coordinates of the sonar image obtained through image registration; and repeating this step M×N times to obtain [symbol] , where M represents a width of the stitched image, N represents a height of the stitched image, M and N denoting a size of a minimum bounding rectangle of an irregular image after stitching; and L represents the number of variance values to be stored; [symbol] represents a set of pixel value variances within the spatial window s₁ and the temporal window t₁, constituting the local variance statistics. Before the pixel value variance ν is stored in [symbol] , the pixel value variance ν is adjusted based on the background variance b∈ [symbol] . The specific method is ν_{new}=ƒ(ν_{old}, b). ƒ is a function for adjusting the ν value based on the background variance, b is obtained by calculating the pixel value variances of each forward-looking sonar image within the spatial window s₂ and the temporal window t₂, b∈ [symbol] , where [symbol] is a set of pixel value variances within the spatial window s₂ and the temporal window t₂, constituting the local background variance statistics. More specifically, f can be:

$$f = {v}_{old} {e}^{- b}$$

This ensures that in regions where b values are large, ν values will be adjusted to be smaller. To ensure that the calculated variance value better represents a local inherent background variance of the image, it is usually set that s₂≥s₁; to ensure that the calculated variance value avoids the influence of local effective information of the image on background modeling, it is usually set that t₂»t₁. For example, s₁ can be set to 21, s₂ can be set to 31, t₁ can be set to 5, and t₂ can be set to 101.

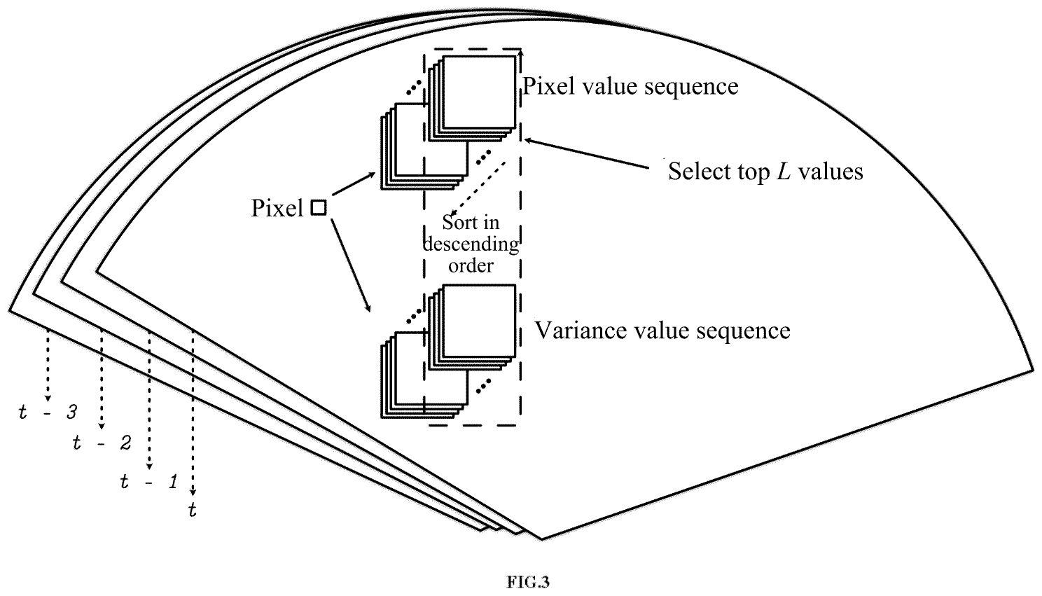

FIG. 3 illustrates four forward-looking sonar images that have undergone rotational displacement transformations, corresponding to times t-3, t-2, t-1, and t. The content of the global variance map [symbol] ∈ [symbol] ^{M×N×L} is illustrated in the figure. In FIG. 3, a pixel x in the global coordinate system is located at coordinates (m, n), where m∈{1, 2, . . . , M}, and n∈{1, 2, . . . , N}. According to the dimensions of [symbol] , there exists a sequence of L variance values at this coordinate position, arranged in descending order. Correspondingly, pixel values of the forward-looking sonar images corresponding to the L variance values are extracted to form a pixel value sequence, providing input for subsequent steps.

Image blending step: A pixel value at each coordinate position of the preliminary stitched image obtained through image registration is calculated to obtain a final fused image. The pixel value at each coordinate position of the preliminary stitched image is obtained by averaging pixel values from the forward-looking sonar images corresponding to the L values at the corresponding coordinate position in the global variance map [symbol] .

This method adapts to non-ideal sonar imaging configurations, and considers both intra-frame and inter-frame artifacts. Single images containing effective information are selected for weighted averaging. This avoids a decrease in the proportion of effective information caused by the participation of images, which do not contain information, in the averaging process. This method can retain image information required by the observer, assist the observer in underwater detection, and reduce the volume of underwater detection data.

The above descriptions are merely preferred implementations of the present disclosure. Although the present disclosure is described as above with preferred embodiments, the present disclosure is not limited to the preferred embodiments. Any person skilled in the art can make many possible variations and modifications to the technical solutions of the present disclosure using the disclosed method and technical content, or modify them to be equivalent examples of the variations, without departing from the scope of technical solutions of the present disclosure. Therefore, any simple modifications, equivalent substitutions, equivalent changes, and modifications made to the above embodiments according to the technical essence of the present disclosure without departing from the contents of the technical solutions of the present disclosure still fall in the protection scope of the technical solutions of the present disclosure.

What is claimed is:

1. A method for stitching forward-looking sonar images while retaining information, comprising: acquisition of a forward-looking sonar image sequence, image registration, information extraction, and image blending;
wherein the image registration specifically comprises: estimating relative rotational displacements of the forward-looking sonar image sequence using a phase correlation method, accumulating to obtain a global rotational displacement, and applying the global rotational displacement to images to obtain a preliminary stitched image;
the information extraction specifically comprises: subjecting the forward-looking sonar image sequence to a temporal window method and a spatial window method to obtain local variance statistics and local background variance statistics, combining the local variance statistics and the local background variance statistics based on weights to obtain corrected local variance statistics, and combining the corrected local variance statistics with the global rotational displacement to obtain a global variance map; and
the image blending specifically comprises: forming a final stitched result from the preliminary stitched image under an influence of the global variance map.

2. The method for stitching forward-looking sonar images while retaining information according to claim 1, wherein said estimating the relative rotational displacements of the forward-looking sonar image sequence using the phase correlation method specifically comprises: estimating relative rotational displacements between forward-looking sonar images at adjacent times using a phase correlation method based on Fourier-Mellin transform.

3. The method for stitching forward-looking sonar images while retaining information according to claim 1, wherein the local variance statistics are calculated using the following method:
calculating pixel value variances of each forward-looking sonar image within a spatial window s₁ and a temporal window t₁ to obtain ν∈ [symbol] , wherein [symbol] represents a set of pixel value variances within the spatial window s₁ and the temporal window t₁, constituting the local variance statistics; and
the local background variance statistics are calculated using the following method:
calculating pixel value variances of each forward-looking sonar image within a spatial window s₂ and a temporal window t₂ to obtain b∈ [symbol] , wherein [symbol] represents a set of pixel value variances within the spatial window s₂ and the temporal window t₂, constituting the local background variance statistics;
wherein to ensure that the calculated variance better represents a local inherent background variance of the image, it is set that s₂≥s₁; to ensure that the calculated variance avoids the influence of local effective information of the image on background modeling, it is set that t₂»t₁.

4. The method for stitching forward-looking sonar images while retaining information according to claim 3, wherein the global variance map [symbol] ∈ [symbol] ^{M×N×L} is specifically obtained by sorting the pixel value variances ν within the spatial window s₁ and the temporal window t₁ in descending order; selecting top L ν values, and storing the selected ν values at spatial positions corresponding to the ν values in [symbol] , wherein the spatial position of the ν value is obtained by adding local coordinates of a pixel on a specific sonar image to global coordinates of the sonar image obtained through image registration; and repeating the step M×N times to obtain [symbol] , wherein M represents a width of the stitched image, N represents a height of the stitched image, M and N denoting a size of a minimum bounding rectangle of an irregular image after stitching; and L represents the number of variance values to be stored.

5. The method for stitching forward-looking sonar images while retaining information according to claim 4, wherein before the pixel value variance ν is stored in [symbol] , the pixel value variance ν is adjusted based on the background variance b∈ [symbol] , with a specific method being ν_{new}=ƒ(ν_{old}, b), wherein ƒ is a function for adjusting the ν value based on the background variance, ν_{old} is a pixel value variance before adjustment, and ν_{new} is a pixel value variance after adjustment.

6. The method for stitching forward-looking sonar images while retaining information according to claim 1, wherein said forming the final stitched result from the preliminary stitched image under the influence of the global variance map is specifically as follows: a pixel value at each coordinate position of the stitched image is obtained by averaging pixel values from the forward-looking sonar images corresponding to L values at a corresponding coordinate position on the global variance map [symbol] , wherein L represents the number of variance values to be stored.
